(19) United States
(12) Patent Application Publication
(10) Pub. No.: US 2023/0406181 A1
(43) Pub. Date: Dec. 21, 2023

(54) PIVOTING ARMREST FOR SEAT

(71) Applicant: Lear Corporation, Southfield, MI (US)

(72) Inventors: Curtis J. Hudson, Macomb, MI (US); James F. Morris, Ypsilanti, MI (US); Thomas Loyal Sundberg, JR., Commerce Township, MI (US); Nizar Freijy, Oxford, MI (US); Pankaj-Aravind Palaskar, Spring Arbor, MI (US)

(73) Assignee: Lear Corporation, Southfield, MI (US)

(21) Appl. No.: 17/826,365

(22) Filed: May 27, 2022

(51) Int. Cl. B60N 2/75

(52) U.S. Cl. CPC B60N 2/753

(57) ABSTRACT

An armrest assembly and method of manufacturing, which may comprise an armrest structure including an integral outer flange extending around essentially an entire periphery of the armrest structure, an integral web extending within the integral outer flange, an integral boss extending laterally from the integral web coaxial with a pivoting axis of the armrest, and integral stiffening ribs extending laterally from the integral web, between the integral outer flange.

### BACKGROUND OF THE INVENTION

This invention relates to a pivoting armrest for a seat, and more particularly to a pivoting armrest for a seat that may be a vehicle seat.

Seats, particularly in vehicles, are known that provide arm rests to improve comfort of a seat occupant. Armrests may also be configured to allow for pivoting relative to the seat. Such pivoting armrests are common on vehicle seats. For armrests on vehicle seats, the armrests may be designed to meet certain automotive vehicle regulations issued by government entities. For example, Economic Commission for Europe (ECE) regulations, which may relate to various aspects of vehicle and components design such as automotive vehicle interiors as well as standards for automotive vehicle seats. In order to provide armrests for vehicle seats that comply with the various standards, some create an armrest center structure that is made from a steel stamping welded to a bent steel rod and has a plastic cap secured to the metal assembly. Additionally, such armrest center structure includes separate part designs for armrest structures relative to right-hand and left-hand armrests (i.e., different structural design for right hand armrests than for left hand armrests). Also, to provide pivoting of the armrest relative to a vehicle seat, a bushing is welded to the metal parts of the armrest center structure.

### SUMMARY OF THE INVENTION

According to an aspect, the invention provides an armrest assembly that may include an armrest structure including an integral outer flange extending around essentially an entire periphery of the armrest structure, an integral web extending within the integral outer flange, an integral boss extending laterally from the integral web coaxial with a pivoting axis of the armrest, and integral stiffening ribs extending laterally from the integral web, between the integral outer flange.

According to an aspect, the invention provides a method of fabricating an armrest assembly that may comprise integrally molding an armrest structure including an integral outer flange extending around essentially an entire periphery of the armrest structure, an integral web extending within the integral outer flange, an integral boss extending laterally from the integral web coaxial with a pivoting axis of the armrest assembly, and integral stiffening ribs extending laterally from the integral web, between the integral outer flange.

According to an aspect, the invention provides an improved structure for a vehicle armrest and method of manufacturing. Acceptable shape and curvature of an armrest structure (e.g., acceptable minimum radii) may be molded directly into armrest structure to comply with, for example, any automotive regulations. Pass through end stop detents for pivotable armrests may be molded into armrest structure. An integrally molded armrest structure may lower weight relative to prior pivoting armrests (e.g., primarily plastic armrest structure versus metal; molded-in honeycomb stiffening ribs, more evenly distributing stress; and weight reduction holes through a web in the armrest structure). An integrally molded armrest structure may be lower cost relative to prior multi-piece metal armrest structure (e.g., one molded plastic piece versus multiple metal stampings welded together reduces number of parts and assembly time for armrest assembly, and no separate left hand and right-hand parts, reducing costs for producing and tracking separate right and left parts).

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic, partially cutaway, perspective view of an armrest assembly.

FIG. 2 is a schematic, perspective view of a portion of an armrest assembly.

FIG. 3 is a schematic, perspective view of a portion of an armrest assembly.

FIG. 4 is a schematic, side view of a portion of an armrest assembly.

FIG. 5 is a schematic, partial cross section through a portion of an armrest assembly.

FIG. 6 is a schematic, perspective view of a portion of an armrest assembly.

FIG. 7 is a schematic, partial cross section view of a portion of an armrest assembly pivotally supported on a portion of a seat.

FIG. 8 is a schematic, perspective view of a portion of an armrest assembly.

### DETAILED DESCRIPTION OF THE PREFERRED EMBODIMENTS

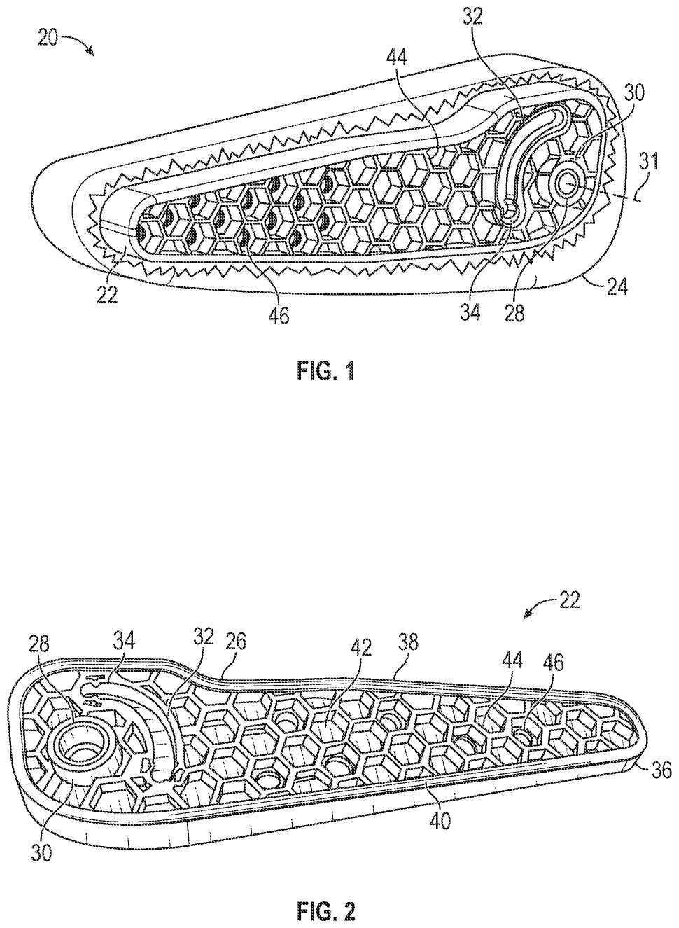

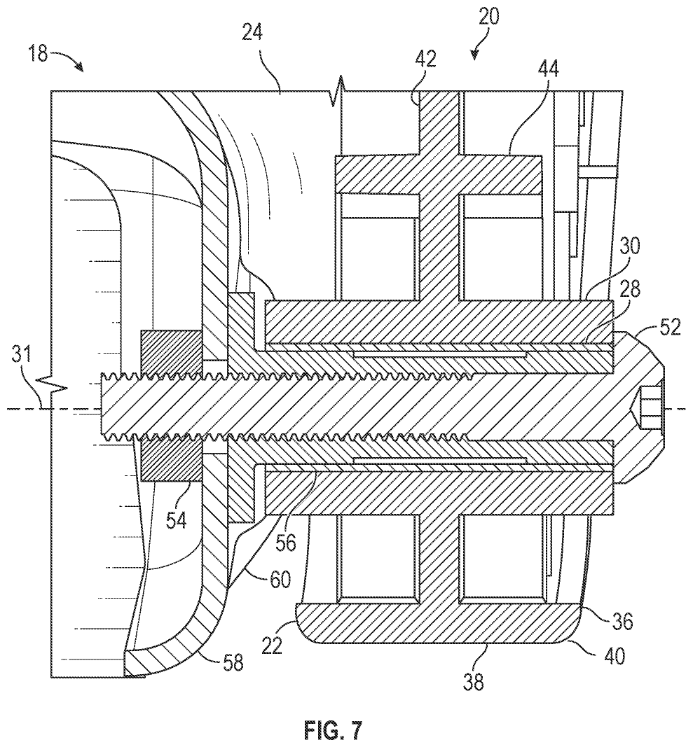

Referring now to the drawings, there is illustrated in FIG. 1 an armrest assembly 20 comprising an armrest structure 22 enclosed within an armrest padding and skin 24. The armrest assembly 20 may be mounted for pivotable movement relative to a seat (e.g., a vehicle seat 18 as shown and discussed relative to FIG. 7).

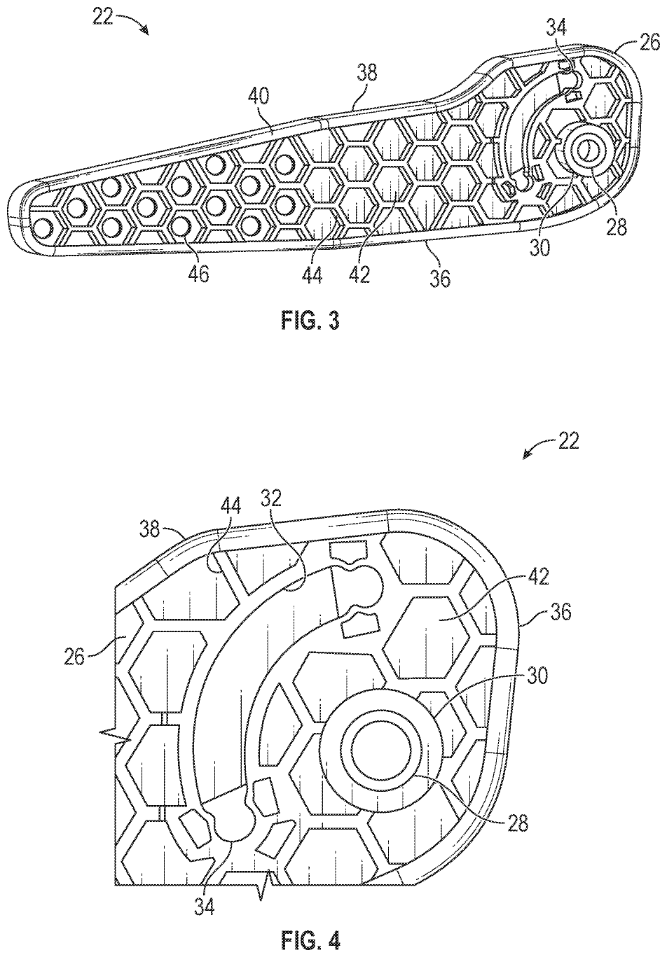

Referring now to FIGS. 1-6, the armrest structure 22 will be discussed in more detail. The armrest structure 22 may be formed as an integral molded plastic arm supporting structure 26 over-molded over a laterally extending bushing 28. The molding may be, for example, injection molding. The term “integral,” and variations of the term integral, as used herein including the claims, means that the element is formed as a singled monolithic piece. The armrest structure 22 may comprise a laterally extending boss 30 molded around and supporting the bushing 28 in a predetermined orientation for pivotally mounting the armrest structure 22 to the vehicle seat, allowing for pivoting about a laterally extending axis 31. A stop pin guide 32 may be molded as part of the armrest structure 22 adjacent to the boss 30. The stop pin guide 32 may comprise a curved channel for guiding a stop pin (not shown) between an armrest deployed (use) position (for use as an armrest by a seat occupant) and an armrest stowed position (out of the way of a seat occupant). The stop pin guide 32 may comprise end detent features 34 at either end of travel of a stop pin, thus limiting pivoting (about the lateral axis 31) at either end of travel between the armrest deployed and stowed positions.

The armrest structure 22 may also comprise an outer flange 36, molded as part of the armrests structure and extending around all or a portion of a periphery 38 of the armrest structure 22. The flange 36 may provide structural support around the periphery of the armrest padding and skin 24. Sides of the outer flange 36 may be molded with radiused corners 40 having radii that may be equal to or greater than any radius limitations specified in any type of automotive regulations (e.g., 3.5 centimeter radius or larger). With the armrest structure 22 being molded as an integral part, the radiused corners 40 having such desirable radii may be molded-in around a portion of or the entire periphery 38 of the armrest structure 22.

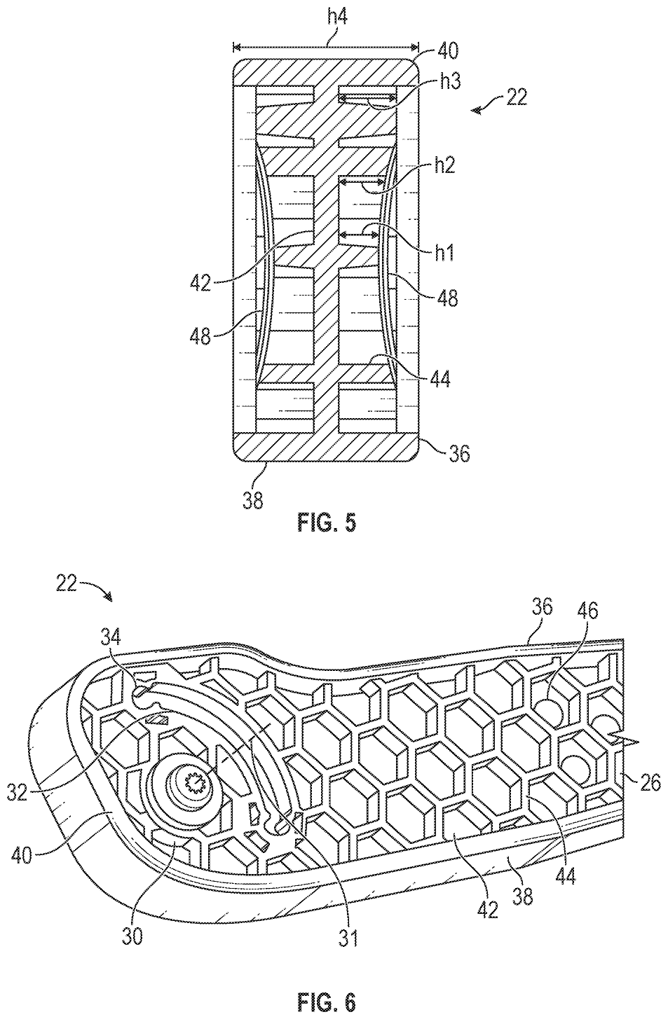

The armrest structure 22 may comprise a web 42 molded within the outer flange 36, providing structural integrity to the armrest structure 22. The web 42 may extend generally normal to the lateral axis 31. Internal stiffening ribs 44 may extend laterally outward from the web 42 in one or both directions and may be integrally molded into the armrest structure 22. The internal stiffening ribs 44 may comprise, for example, a honeycomb shape extending to the outer flange 36. A honeycomb shape may more evenly distribute stresses caused during use of the armrest structure 22 by a seat occupant. A lateral height of the internal stiffening ribs 44 may vary for different portions of the armrest structure 22—this variation may be in a fore-aft direction, in an up-down direction, or both (e.g., 165 centimeter diameter, or greater, curvature for reduction of lateral rib height). The lateral height variation for the internal stiffening ribs may assist with meeting any limitations specified in any type of automotive regulations. The varying lateral height may be created as the armrest structure 22 is being molded. For example, in an up-down direction (when the armrest is oriented in a deployed position), the lateral height h1 (see in particular FIG. 5), closest to a center of the web, may be less than lateral height h2, which may be less than lateral height h3, closest to the outer flange 36, which may have a lateral height h4 that is greater than other heights h1, h2, or h3. This lateral rib height variation may also occur in the fore-aft direction (when the armrest is oriented in a deployed position), as illustrated by curved lines 48 in FIG. 5). Spaced-apart lightening holes 46 may be formed in the web 42 when the armrest structure 22 is molded. Such varied height of ribs 44 and lightening holes 46 formed during molding may allow for reduced weight of the armrest structure 22 while still providing overall desired strength characteristics of the armrest structure 22. Additionally, the boss 30, for example, may be molded with a greater lateral height than lateral height h4 (see for example, FIG. 7).

Referring now to FIG. 7, with reference to FIGS. 1-6, an example of an armrest assembly 20 mounted to a vehicle seat 18 is illustrated. The armrest structure 22, armrest padding and skin 24, bushing 28, boss 30, lateral axis 31, outer flange 36, periphery 38, radiused corner 40, web 42, and internal stiffening ribs 44 have already been discussed relative to FIGS. 1-6 and so will not be discussed in more detail relative to FIG. 7. In FIG. 7, the armrest assembly 20 is illustrated mounted to the vehicle seat 18 via an armrest pivoting support pin 52. The armrest pivoting support pin 52 may be aligned with the lateral axis 31 for pivoting of the armrest assembly 20 about this axis 31 relative to the seat 18. The armrest pivoting support pin 52 may extend through a support 56, which extends through the bushing 28, through a seat padding-outer skin 60 and through seat structure 58, with a nut 54 retaining the pin 52 to the seat structure 58. The armrest assembly 20 may now move with the seat 18 in up-down and fore-aft directions. A stop pin may be employed to limit pivoting of the armrest assembly 20 relative to the seat 18 between the deployed position and the stowed position.

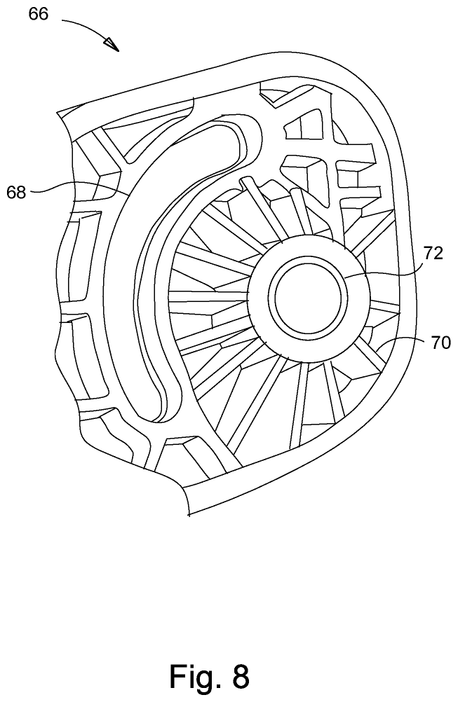

Referring now to FIG. 8, an armrest structure 66 having a somewhat modified stop pin guide 68 and internal stiffening ribs 70 surrounding the boss 30 is illustrated. The stop pin guide 68 may extend along an arc without end detent features defining each end of the arc. This configuration of stop pin guide 68 may provide for limiting the arc of travel between a deployed position and a stowed position without positive end locking stops. The internal stiffening ribs 70 surrounding the boss 30 may be more oriented in a radial pattern, providing support and load distribution around the area of the bushing 72, which may still define a lateral axis about which the armrest structure 66 pivots relative to a seat. The internal stiffening ribs 70 in the more radial pattern may also provide for increased strength in a lateral load direction.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An armrest assembly comprising:
an armrest structure including an integral outer flange extending around essentially an entire periphery of the armrest structure, an integral web extending within the integral outer flange, an integral boss extending laterally from the integral web coaxial with a pivoting axis of the armrest assembly, and integral stiffening ribs extending laterally from the integral web, between the integral outer flange.

2. The armrest assembly of claim 1 further comprising a bushing retained within the integral boss and coaxial therewith about the pivoting axis.

3. The armrest assembly of claim 2 further comprising an armrest padding and skin enclosing essentially the entire armrest structure.

4. The armrest assembly of claim 1 further comprising an armrest padding and skin enclosing essentially the entire armrest structure.

5. The armrest assembly of claim 1 wherein the integral stiffening ribs comprise a honeycomb structure extending within the integral outer flange.

6. The armrest assembly of claim 5 wherein the integral web includes lightening holes therethrough, located within the honeycomb structure of the integral stiffening ribs.

7. The armrest assembly of claim 1 further comprising an integral stop pin guide, adjacent to integral boss and having an arc defining an extent of pivoting of the armrest assembly between a deployed position and a stowed position.

8. The armrest assembly of claim 1 wherein the integral outer flange includes radiused corners, on lateral corners and extending essentially around the entire periphery of the armrest structure.

9. The armrest assembly of claim 1 wherein the integral stiffening ribs comprise varied lateral height, with a greater lateral height immediately adjacent to the integral outer flange and a lesser lateral height in a center region spaced from the integral outer flange.

10. The armrest assembly of claim 1 further comprising a bushing retained within the integral boss and coaxial therewith about the pivoting axis, a generally cylindrical support contained within and coaxial with the bushing, and an armrest pivoting support pin located in the cylindrical support and configured to be secured to a seat for pivotal movement of the armrest assembly relative to the seat.

11. The armrest assembly of claim 10 further comprising an armrest padding and skin enclosing essentially the entire armrest structure, with an opening through which the armrest pivoting support pin extends.

12. A method of fabricating an armrest assembly comprising:
integrally molding an armrest structure including an integral outer flange extending around essentially an entire periphery of the armrest structure, an integral web extending within the integral outer flange, an integral boss extending laterally from the integral web coaxial with a pivoting axis of the armrest assembly, and integral stiffening ribs extending laterally from the integral web, between the integral outer flange.

13. The method of claim 12 further comprising, over-molding the armrest structure around a bushing retained within the integral boss and coaxial therewith about the pivoting axis.

14. The method of claim 12 wherein the armrest structure is integrally molded the same for both a right-hand and a left-hand armrest assembly.

15. The method of claim 12 further comprising, assembling an armrest padding and skin to essentially enclose the entire armrest structure.

16. The method of claim 12 wherein the integral stiffening ribs are integrally molded, shaped as a honeycomb structure extending within the integral outer flange.

17. The method of claim 16 wherein the integral web is molded with lightening holes therethrough, located within the honeycomb structure of the integral stiffening ribs.

18. The method of claim 12 further including integrally molding an integral stop pin guide into the armrest structure, the integral stop pin guide adjacent to integral boss and having an arc defining an extent of pivoting of the armrest assembly between a deployed position and a stowed position.

19. The method of claim 12 wherein the integral outer flange is molded with radiused corners, on lateral corners and extending essentially around the entire periphery of the armrest structure.

20. The method of claim 12 further comprising over-molding the armrest structure around a bushing retained within the integral boss and coaxial therewith about the pivoting axis, inserting a generally cylindrical support within and coaxial with the bushing, and inserting an armrest pivoting support pin through the cylindrical support and securing to a seat for pivotal movement of the armrest assembly relative to the seat.
